(19) United States
(12) Patent Application Publication
(10) Pub. No.: US 2022/0266482 A1
(43) Pub. Date: Aug. 25, 2022

(54) APPARATUS FOR MANUFACTURING PIPE FOR COWL CROSSBAR AND METHOD OF MANUFACTURING PIPE FOR COWL CROSSBAR USING THE SAME

(71) Applicant: HYUNDAI MOBIS Co., Ltd., Seoul (KR)

(72) Inventor: Ik Keun CHOI, Yongin-si (KR)

(73) Assignee: HYUNDAI MOBIS Co., Ltd., Seoul (KR)

(21) Appl. No.: 17/667,795

(22) Filed: Feb. 9, 2022

(30) Foreign Application Priority Data
Feb. 9, 2021 (KR) 10-2021-0018686

(51) Int. Cl. B29C 43/22; B29C 43/00; B29C 43/34

(52) U.S. Cl. CPC B29C 43/224; B29C 43/003; B29C 43/34; B29C 2043/3433; B29K 2023/12

(57) ABSTRACT

An apparatus for manufacturing a pipe for a cowl crossbar, which is disposed inside a vehicle body in a lateral direction. The apparatus includes a first extruder to receive a pipe material made of polypropylene (PP) and to extrude the pipe material made of PP; a second extruder to receive the pipe material made of PP extruded from the first extruder and a pipe material made of long glass fiber (LGF), and to extrude a pipe material made of PP and LGF; a first compression molding machine to compress the pipe material made of PP and LGF extruded from the second extruder and to form a first pipe semi-finished product; and a second compression molding machine to compress the pipe material made of PP and LGF extruded from the second extruder and to form a second pipe semi-finished product.

### CROSS-REFERENCE TO RELATED APPLICATION

This application claims priority to and the benefit of Korean Patent Application No. 10-2021-0018686, filed on Feb. 9, 2021, the disclosure of which is incorporated herein by reference in its entirety.

### BACKGROUND

### 1. Field of the Invention

The present invention relates to a pipe for a cowl crossbar, and more particularly, to an apparatus for manufacturing a pipe for a cowl crossbar, in which the number of manufacturing processes of the pipe is reduced, and a method of manufacturing a pipe for a cowl crossbar using the same.

### 2. Discussion of Related Art

A cowl crossbar is one part of a cockpit module of a vehicle and serves to guide and support cockpit electronic parts such as a steering shaft, an instrument panel, an air conditioning system, an airbag, a car audio system, and the like.

Further, the cowl crossbar is a framework for preventing bending or warping in a lateral direction of the vehicle and increasing the durability of a vehicle body, and the cowl crossbar protects passengers safely when a vehicle collision accident occurs.

The cowl crossbar includes a pipe, pipe caps coupled to both ends of the pipe, side brackets that are coupled to a corresponding one of the pipe caps to connect the pipe to both ends of the vehicle body, a pin member that passes through the side brackets in a direction of the vehicle body to guide a coupling direction of the vehicle body, a dash mounting member that is formed in a section between both ends of the pipe and fastened to a dash panel, and a central support that is formed in the section between both ends of the pipe and coupled to a lower portion of the vehicle body, and the cowl crossbar occupies about 35% of the weight of the cockpit module and is manufactured by injection-molding a metal material such as steel or the like or a composite material of aluminum, magnesium, plastic, or the like.

Meanwhile, among the entire section of the pipe, a section of the pipe in a direction in which a driver and a center fascia are placed may be formed to have a large diameter such that an amount of deformation of the pipe is minimized when a vehicle collision accident occurs, and the remaining section of the pipe may be formed to have a small diameter such that the weight of the pipe is reduced.

That is, a pipe having a large diameter and a pipe having a small diameter are provided separately and the pipes are bonded through a bracket to manufacture a single pipe.

Conventionally, in order to manufacture such a pipe, a thick pipe and a thin pipe are assembled through about seven processes, including a thick pipe manufacturing and injection-molding process, a thin pipe manufacturing and injection-molding process, a thick pipe and thin pipe sub-assembly process, a thick pipe and thin pipe assembly process, and the like.

Therefore, there is a problem in that there are many processes for manufacturing the pipe, and thus a manufacturing cost is also increased.

### SUMMARY OF THE INVENTION

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an apparatus for manufacturing a pipe for a cowl crossbar, which is disposed inside a vehicle body in a lateral direction, includes: a first extruder configured to receive a pipe material made of polypropylene (PP) and to extrude the pipe material made of PP; a second extruder configured to receive the pipe material made of PP extruded from the first extruder and a pipe material made of long glass fiber (LGF), and to extrude a pipe material made of PP and LGF; a first compression molding machine configured to compress the pipe material made of PP and LGF extruded from the second extruder and to form a first pipe semi-finished product; and a second compression molding machine configured to compress the pipe material made of PP and LGF extruded from the second extruder and to form a second pipe semi-finished product.

The first compression molding machine may include a first upper mold configured to press an upper portion of the pipe material extruded from the second extruder and a first lower mold configured to press a lower portion of the pipe material extruded from the second extruder, and the second compression molding machine may include a second upper mold configured to press the upper portion of the pipe material extruded from the second extruder and a second lower mold configured to press the lower portion of the pipe material extruded from the second extruder.

The first upper mold may include a first upper body part defining a body and an upper protrusion protruding from the first upper body part, and the first lower mold may include a first lower body part defining a body and having an upper surface in contact with a lower surface of the first upper body part, a lower recessed part in which the upper protrusion is inserted, and a lower flange forming part disposed on both sides of the lower recessed part in a concave shape.

The lower flange forming part may include a first lower flange forming part disposed at one end of the lower recessed part and a second lower flange forming part disposed at another end of the lower recessed part in a direction opposite to the first lower flange forming part, and a central line of the first lower flange forming part and a central line of the second lower flange forming part may be different from each other.

The second upper mold may include a second upper body part defining a body, an upper recessed part recessed from the second upper body part, and an upper flange forming part formed on both sides of the upper recessed part in a concave shape, and the second lower mold may include a second lower body part defining a body and having an upper surface in contact with a lower surface of the second upper body part and a lower protrusion protruding from the second lower body part and configured to be inserted into the upper recessed part.

The upper flange forming part may include a first upper flange forming part disposed at one end of the upper recessed part and a second upper flange forming part disposed at another end of the upper recessed part in a direction opposite to the first upper flange forming part, and a central line of the first upper flange forming part and a central line of the second upper flange forming part may be different from each other.

In another general aspect, a method of manufacturing a pipe for a cowl crossbar, which is disposed inside a vehicle body in a lateral direction, includes placing a pipe material between a first upper mold and a first lower mold, sliding the first upper mold and the first lower mold in a direction facing each other, pressing, by the first upper mold and the first lower mold, the pipe material and forming a first pipe semi-finished product, sliding the first upper mold and the first lower mold in a direction opposite to the direction facing each other and performing form removal on the first pipe semi-finished product from the first upper mold and the first lower mold, placing the pipe material between a second upper mold and a second lower mold, sliding the second upper mold and the second lower mold in a direction facing each other, pressing, by the second upper mold and the second lower mold, the pipe material and forming a second pipe semi-finished product, sliding the second upper mold and the second lower mold in a direction opposite to the direction facing each other and performing form removal on the second pipe semi-finished product from the second upper mold and the second lower mold, and forming the pipe by coupling the first pipe semi-finished product and the second pipe semi-finished product.

The pipe material may be a combination of polypropylene (PP) and long glass fiber (LGF).

A content of the PP may be 50%, and a content of the LGF is 50%.

The content of the PP may be 40%, and the content of the LGF is 60%.

The pipe may include a large-diameter part and a small-diameter part, and an outer diameter of the large-diameter part may be greater than an outer diameter of the small-diameter part.

In the forming of the pipe by coupling the first pipe semi-finished product and the second pipe semi-finished product, the first pipe semi-finished product and the second pipe semi-finished product may be coupled to each other by rivet coupling.

The rivet coupling may be performed by fastening a rivet bolt and a rivet nut.

In the forming of the pipe by coupling the first pipe semi-finished product and the second pipe semi-finished product, the first pipe semi-finished product and the second pipe semi-finished product may be coupled to each other by welding coupling.

The welding coupling may include laser welding.

In the forming of the pipe by coupling the first pipe semi-finished product and the second pipe semi-finished product, the first pipe semi-finished product and the second pipe semi-finished product may be coupled to each other by a combination of rivet coupling and welding coupling.

Other features and aspects will be apparent from the following detailed description, the drawings, and the claims.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic view illustrating a pipe manufacturing process using an apparatus for manufacturing a pipe for a long fiber-reinforced thermoplastics by direct compounding (LFT-D) press method according to a method of manufacturing a pipe for a cowl crossbar of the present invention;

FIG. 2 is a cross-sectional view illustrating a first compression molding machine of the apparatus for manufacturing the pipe for a cowl crossbar of the present invention;

FIG. 3 is a cross-sectional view illustrating a second compression molding machine of the apparatus for manufacturing the pipe for a cowl crossbar of the present invention;

FIGS. 4A and 4B are perspective views illustrating a first lower mold and a second upper mold of the apparatus for manufacturing the pipe for a cowl crossbar of the present invention;

FIGS. 5A, 5B, and 5C are views illustrating a first lower mold, a second upper mold, and a state of use of the pipe of an apparatus for manufacturing a pipe according to another embodiment of the present invention;

FIGS. 6A, 6B, 6C, 6D, 6E, 6F, 6G, 6H, and 6I are process diagrams illustrating a method of manufacturing a pipe for a cowl crossbar according to an embodiment of the present invention;

FIG. 7 is a flowchart illustrating the method of manufacturing the pipe for a cowl crossbar according to the embodiment of the present invention;

FIGS. 8A and 8B shows views illustrating an apparatus for manufacturing a pipe for a cowl crossbar according to another embodiment of the present invention; and

FIGS. 9A and 9B are a perspective view and a cross-sectional view illustrating a pipe manufactured by the apparatus for manufacturing the pipe for a cowl crossbar illustrated in FIGS. 8A and 8B.

### DETAILED DESCRIPTION OF EXEMPLARY EMBODIMENTS

Embodiments of the present invention are provided to fully explain the present invention to those skilled in the art. The following embodiments may be modified in several different forms and the scope of the present invention is not limited to the following embodiments. Rather, the embodiments are provided to thoroughly complete the disclosure and fully convey the concept of the present invention to those skilled in the art. In addition, in the accompanying drawings, each component is exaggerated for convenience and clarity of description and the same reference numerals in the drawings refer to the same elements. As used herein, the term “and/or” includes any and all combinations of one or more of the associated listed items.

Terms used in this specification are considered in a descriptive sense only and not for purposes of limitation.

As used herein, the singular forms “a” and “an” are intended to include the plural forms as well, unless the context clearly indicates otherwise. Further, it should be understood that the terms “comprise,” “comprising,” “include,” and/or “including,” when used herein, specify the presence of stated shapes, integers, steps, operations, members, elements, or combinations thereof, but do not preclude the presence or addition of one or more other shapes, integers, steps, operations, members, elements, or combinations thereof.

Hereinafter, exemplary embodiments of the present invention will be described in detail with reference to the accompanying drawings.

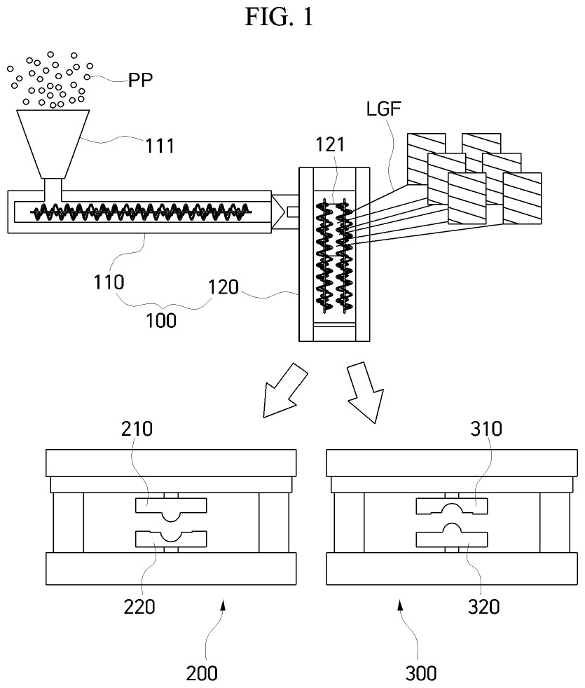

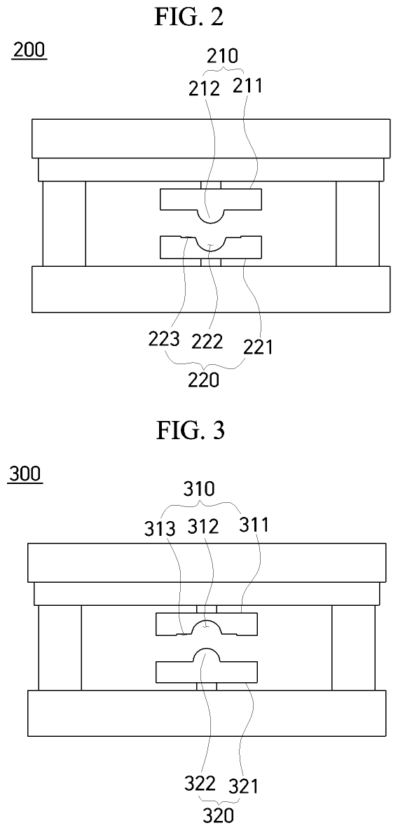

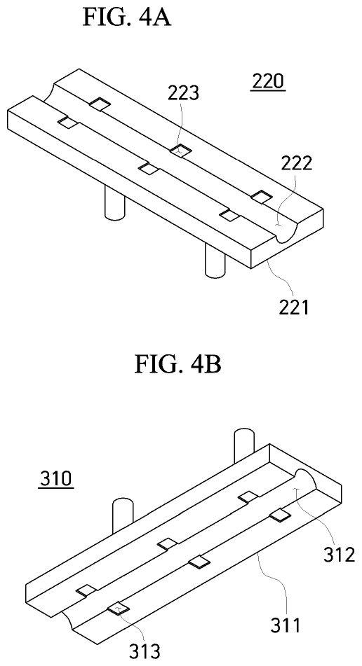

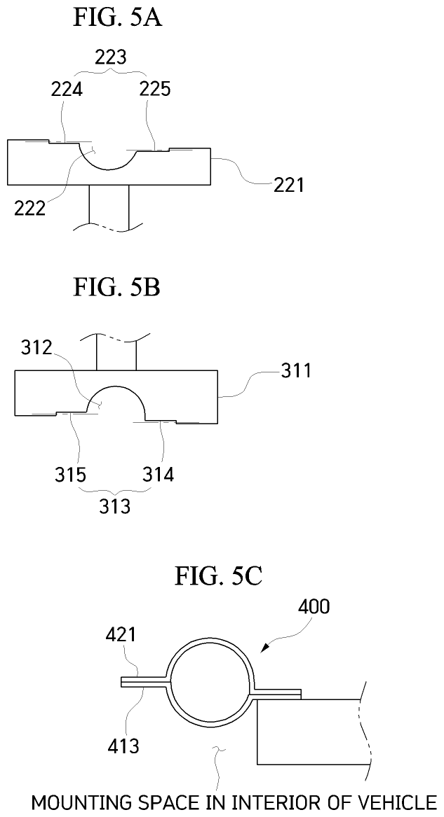

FIG. 1 is a schematic view illustrating a pipe manufacturing process using an apparatus for manufacturing a pipe for a long fiber-reinforced thermoplastics by direct compounding (LFT-D) press method according to a method of manufacturing a pipe for a cowl crossbar of the present invention, FIG. 2 is a cross-sectional view illustrating a first compression molding machine of the apparatus for manufacturing the pipe for a cowl crossbar of the present invention, FIG. 3 is a cross-sectional view illustrating a second compression molding machine of the apparatus for manufacturing the pipe for a cowl crossbar of the present invention, FIGS. 4A and 4B are perspective views illustrating a first lower mold and a second upper mold of the apparatus for manufacturing the pipe for a cowl crossbar of the present invention, and FIGS. 5A to 5C are views illustrating a first lower mold, a second upper mold, and a state of use of the pipe of an apparatus for manufacturing a pipe according to another embodiment of the present invention.

Referring to FIG. 1, a pipe 400 for a cowl crossbar disposed in an inside of a vehicle body in a lateral direction is manufactured using an LFT-D press method.

In the LFT-D press method, various types of equipment are used for a process from raw materials to finished products due to the characteristic of the process, and the LFT-D press method is a method of making a product by mixing raw materials, extruding the mixed raw materials, and then performing press-molding using a compression molding machine.

Such a LFT-D press method enables serial processing from raw material mixing and extrusion to press molding, and has higher productivity than injection molding.

An apparatus for manufacturing the pipe 400 for a cowl crossbar for the LFT-D press method includes an extruder 100, a first compression molding machine 200, and a second compression molding machine 300, as illustrated in FIG. 1.

A pipe material 401 is put into the extruder 100 and the extruder 100 extrudes the put pipe material 401.

The extruder 100 includes a first extruder 110 and a second extruder 120.

The first extruder 110 has a first inlet 111 formed therein and a pipe material 401 made of polypropylene (PP) is put into the first extruder 110 through the first inlet 111.

Further, the PP is melted by the first extruder 110 and extruded by the second extruder 120.

The second extruder 120 has a second inlet 121 formed therein and a pipe material 401 made of long glass fiber (LGF) is put into the second extruder 120 through the second inlet 121.

That is, in the present invention, the pipe material 401 for manufacturing the pipe 400 for a cowl crossbar is made of a combination of PP and LGF.

Further, by putting the LGF separately from the PP through the second inlet 121, excessive cutting of the fiber may be prevented.

The first compression molding machine 200 compresses the pipe material 401 made of the PP and the LGF, which is extruded from the extruder 100, specifically, the second extruder 120, to form a first pipe semi-finished product 410.

Further, the second compression molding machine 300 compresses the pipe material 401 made of PP and LGF, which is extruded from the extruder 100, specifically, the second extruder 120, to form a second pipe semi-finished product 420.

That is, the first pipe semi-finished product 410 and the second pipe semi-finished product 420 are formed using the first compression molding machine 200 and the second compression molding machine 300 of the present invention, respectively.

Here, the semi-finished product refers to a part, which will be transmitted to a next process after one process is completed in the case in which a product is completed through several processes, and refers to a product that has not become a complete product but has been processed for now.

In the pipe 400 for a cowl crossbar according to the embodiment of the present invention, a single pipe 400 is formed by assembling the first pipe semi-finished product 410 and the second pipe semi-finished product 420.

Referring to FIG. 2, the first compression molding machine 200 includes a first upper mold 210 and a first lower mold 220.

The first upper mold 210 presses an upper portion of the pipe material 401 extruded from the extruder 100.

The first upper mold 210 includes a first upper body part 211 and an upper protrusion 212.

The first upper body part 211 forms a body of the first upper mold 210.

Further, the upper protrusion 212 protrudes downward from a center of the first upper body part 211.

A cross section of the upper protrusion 212 may have a semicircular shape.

The upper protrusion 212 presses the pipe material 401 placed between the first upper mold 210 and the first lower mold 220 to form an inner circumferential surface of the first pipe semi-finished product 410.

Further, the first lower mold 220 is disposed below the first upper mold 210 and presses a lower portion of the pipe material 401 extruded from the extruder 100.

The first lower mold 220 includes a first lower body part 221, a lower recessed part 222, and a lower flange forming part 223.

The first lower body part 221 forms a body of the first lower mold 220.

Further, when the first upper mold 210 and the first lower mold 220 press the pipe material 401, an upper surface of the first lower body part 221 is brought into contact with a lower surface of the first upper body part 211.

The lower recessed part 222 is a groove formed in a center of the first lower body part 221 and is formed to have a shape corresponding to the upper protrusion 212.

Further, when the first upper mold 210 and the first lower mold 220 press the pipe material 401, the upper protrusion 212 is inserted into the lower recessed part 222.

The lower recessed part 222 presses the pipe material 401 placed between the first upper mold 210 and the first lower mold 220 to form an outer circumferential surface of the first pipe semi-finished product 410.

That is, when the first upper mold 210 and the first lower mold 220 press the pipe material 401, the upper protrusion 212 and the lower recessed part 222 allow a cross section of the first pipe semi-finished product 410 to have a half-pipe shape.

The lower flange forming part 223 is a region that forms a flange 413 serving as a bracket of the pipe 400 and is formed on both sides of the lower recessed part 222 in a concave shape.

As illustrated in FIG. 4A, a plurality of lower flange forming parts 223 may be formed to be spaced apart from each other in a longitudinal direction of the first lower body part 221 according to a position of the flange 413 of the pipe 400 according to a design layout of a vehicle.

Referring to FIG. 3, the second compression molding machine 300 includes a second upper mold 310 and a second lower mold 320.

The second upper mold 310 presses the upper portion of the pipe material 401 extruded from the extruder 100.

Further, the second lower mold 320 is disposed below the second upper mold 310 and presses the lower portion of the pipe material 401 extruded from the extruder 100.

The second upper mold 310 includes a second upper body part 311, an upper recessed part 312, and an upper flange forming part 313.

The second upper body part 311 forms a body of the second upper mold 310.

Further, the upper recessed part 312 is formed to have a shape of a groove formed in a center of the second upper body part 311.

The upper recessed part 312 presses the pipe material 401 placed between the second upper mold 310 and the second lower mold 320 to form an outer circumferential surface of the second pipe semi-finished product 420.

The upper flange forming part 313 is a region that forms a flange 421 serving as a bracket of the pipe 400 and is formed on both sides of the upper recessed part 312 in a concave shape.

As illustrated in FIG. 4B, a plurality of upper flange forming parts 313 may be formed to be spaced apart from each other in a longitudinal direction of the second lower body part 321 according to a position of the flange 421 of the pipe 400 according to the design layout of the vehicle.

Further, the upper flange forming part 313 is formed to have a shape corresponding to the lower flange forming part 223, and when the first pipe semi-finished product 410 and the second pipe semi-finished product 420 are coupled to each other, the first pipe semi-finished product 410 and the second pipe semi-finished product 420 are in surface contact with each other.

The second lower mold 320 includes a second lower body part 321 and a lower protrusion 322.

The second lower body part 321 forms a body of the second lower mold 320.

Further, when the second upper mold 310 and the second lower mold 320 press the pipe material 401, an upper surface of the second lower body part 321 is brought into contact with a lower surface of the second upper body part 311.

Further, the lower protrusion 322 protrudes upward from a center of the second lower body part 321.

A cross section of the lower protrusion 322 may have a semicircular shape.

Further, when the second upper mold 310 and the second lower mold 320 press the pipe material 401, the lower protrusion 322 is inserted into the upper recessed part 312.

The lower protrusion 322 presses the pipe material 401 placed between the second upper mold 310 and the second lower mold 320 to form an inner circumferential surface of the second pipe semi-finished product 420.

That is, when the second upper mold 310 and the second lower mold 320 press the pipe material 401, the upper recessed part 312 and the lower protrusion 322 allow a cross section of the second pipe semi-finished product 420 to have a shape of a half-pipe 400.

The first pipe semi-finished product 410 and the second pipe semi-finished product 420 may be formed to have a cross section having the shape of the half-pipe 400 through the apparatus for manufacturing the pipe 400 for a cowl crossbar as described above, and a single pipe 400 may be formed by coupling the first pipe semi-finished product 410 and the second pipe semi-finished product 420 to each other.

In this case, in the lower flange forming part 223 and the upper flange forming part 313 that form the flanges 413 and 421 serving as the brackets of the pipe 400, the flange forming parts formed on both sides of the pipe 400 may be formed in a central line of the pipe 400 or may be formed in different central lines.

To this end, the lower flange forming part 223 includes a first lower flange forming part 224 and a second lower flange forming part 225, as illustrated in FIG. 5A.

The first lower flange forming part 224 is formed on one end of the lower recessed part 222, and the second lower flange forming part 225 is formed on another end of the lower recessed part 222 in a direction opposite to the first lower flange forming part 224.

A central line of the first lower flange forming part 224 and a central line of the second lower flange forming part 225 are different from each other.

Further, the upper flange forming part 313 includes a first upper flange forming part 314 and a second upper flange forming part 315, as illustrated in FIG. 5B.

The first upper flange forming part 314 is formed on one end of the upper recessed part 312 so as to correspond to the first lower flange forming part 224, and the second upper flange forming part 315 is formed on another end of the upper recessed part 312 in a direction opposite to the first upper flange forming part 314 so as to correspond to the second lower flange forming part 225.

A central line of the first upper flange forming part 314 and a central line of the second upper flange forming part 315 are different from each other.

Accordingly, as illustrated in FIG. 5C, since heights of the flanges formed on both sides of the pipe 400 are different from each other, the flanges may be variously changed and used according to a design layout of a mounting space in an interior of a vehicle.

Further, in the first pipe semi-finished product 410 and the second pipe semi-finished product 420, the body parts and the flanges are molded using the same material consisting of a combination of PP and LGF, and thus coupling force between the first pipe semi-finished product 410 and second pipe semi-finished product 420 and the flanges may be increased.

Hereinafter, a method of manufacturing a pipe 400 for a cowl crossbar using the apparatus for manufacturing the pipe 400 for a cowl crossbar will be described with reference to the accompanying drawings.

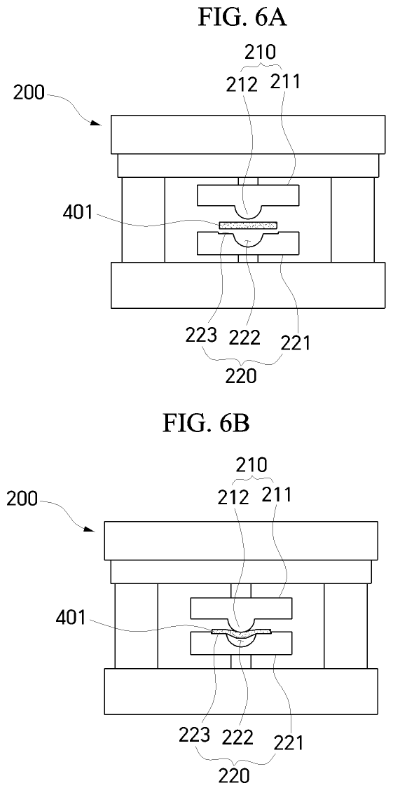

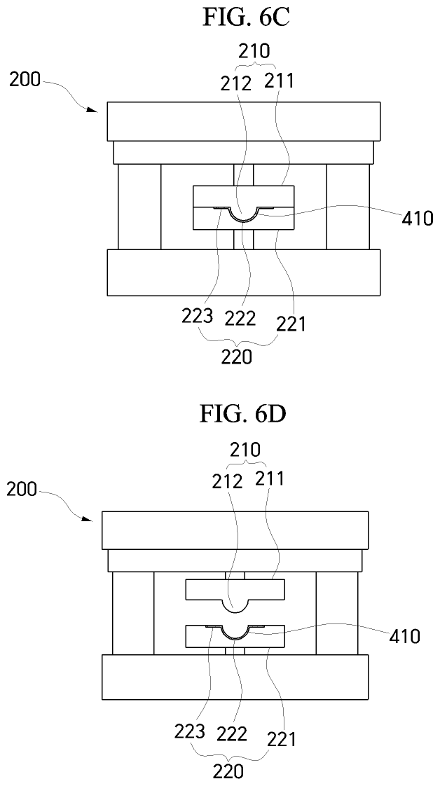

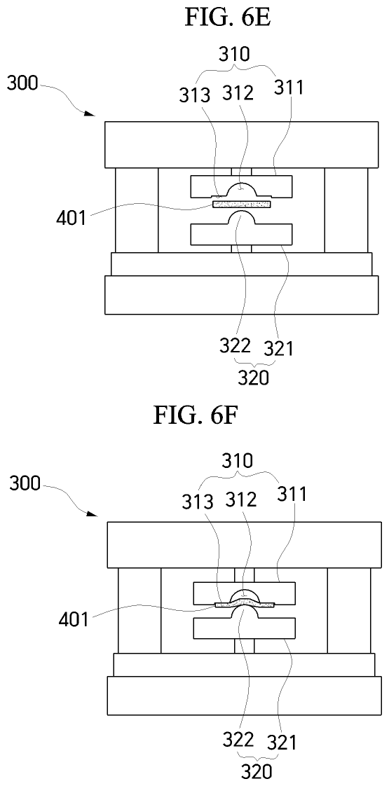

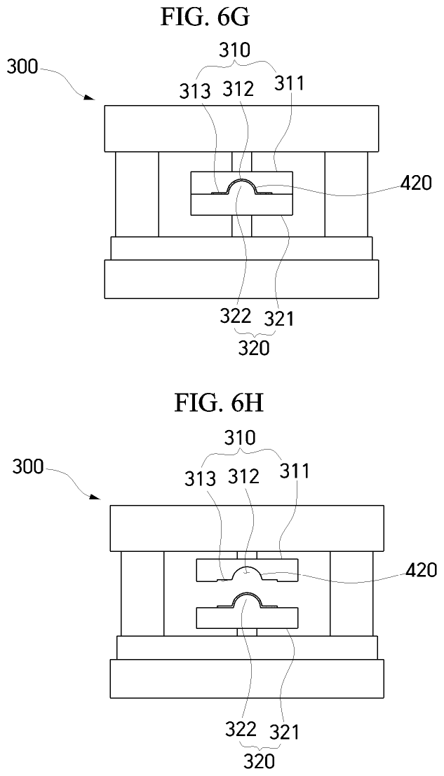

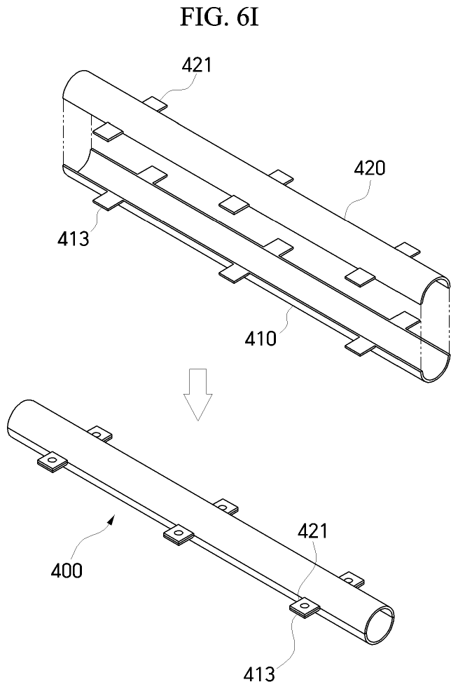

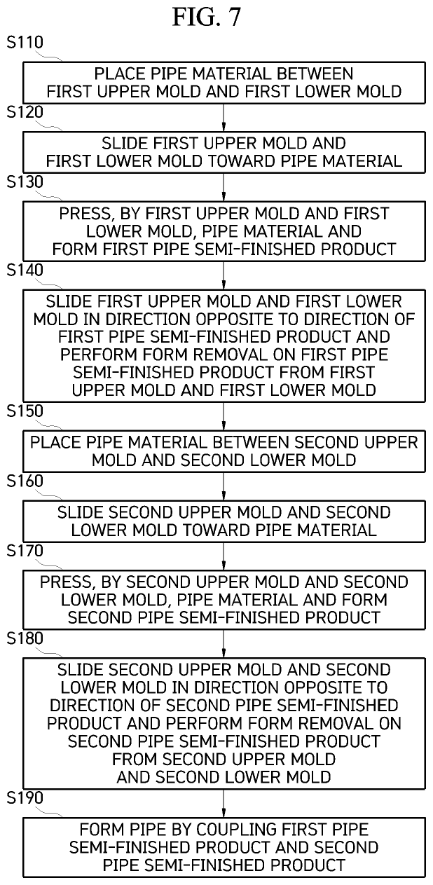

FIGS. 6A to 6I are process diagrams illustrating a method of manufacturing a pipe 400 for a cowl crossbar according to an embodiment of the present invention, and FIG. 7 is a flowchart illustrating the method of manufacturing the pipe 400 for a cowl crossbar according to the embodiment of the present invention.

First, as illustrated in FIG. 1, PP is put into a first extruder 110 through a first inlet 111 and LGF is put into a second extruder 120 through a second inlet 121.

That is, in the present invention, a pipe material 401 for manufacturing the pipe 400 for a cowl crossbar is made of a combination of the PP and the LGF.

Here, a content of the PP may be 50%, and a content of the LGF may be 50%.

Further, a content of the PP may be 40%, and a content of the LGF may be 60%.

When the content of the PP is less than 40%, there may be a problem in that the weight of the pipe material 401 is increased due to a relatively high content of the LGF, and when the content of the PP exceeds 50%, there may be a problem in that mechanical characteristics of the pipe material 401 are degraded.

Further, the LGF is used to improve the mechanical characteristics of the pipe 400, and the content of the LGF may range from about 50 to 60%, as described above.

When the content of the LGF is too small, there may be a problem in that the weight of the pipe material 401 is lowered but the mechanical characteristics such as strength, durability, and the like are degraded, and when the content of the LGF exceeds 60%, there may be a problem in that the weight of the pipe material 401 is increased.

Since the pipe 400 manufactured using the PP and LGF materials has a very superior vibration absorption property due to the material characteristics as compared to steel, the shaking of a steering wheel, which is caused by idling when the vehicle is stopped or driving, may be suppressed, and thus noise, vibration, and harshness (NVH) performance may be improved.

Next, the PP is melted by the first extruder 110 and extruded by the second extruder 120.

Further, the second extruder 120 melts and mixes the PP and the LGF, which are extruded from the first extruder 110.

Here, the extrusion refers to a process of compounding by melting and mixing raw materials.

A first pipe semi-finished product 410 and a second pipe semi-finished product 420 are formed by compressing the pipe material 401 made of PP and LGF using a first compression molding machine 200 and a second compression molding machine 300, respectively.

Specifically, the first compression molding machine 200 for molding the first pipe semi-finished product 410 includes a first upper mold 210 and a first lower mold 220.

First, as illustrated in FIG. 6A, the pipe material 401 made of the PP and the LGF is placed between the first upper mold 210 and the first lower mold 220 of the first compression molding machine 200 (S110).

Next, as illustrated in FIG. 6B, the first upper mold 210 and the first lower mold 220 are slid toward the pipe material 401 (S120).

That is, as illustrated in FIG. 6C, the pipe material 401 made of the PP and the LGF is pressed by an upper protrusion 212 of the first upper mold 210 and a lower recessed part 222 of the first lower mold 220 to form the first pipe semi-finished product 410 having a shape of a half-pipe 400 (S130).

Therefore, the upper protrusion 212 of the first upper mold 210 and the lower recessed part 222 of the first lower mold 220 may easily form an inner circumferential surface of the pipe 400 by using a LFT-D press method.

Further, a flange 413 is formed on an outer circumferential surface of the first pipe semi-finished product 410 by a lower flange forming part 223 formed in the first lower mold 220.

The first upper mold 210 and the first lower mold 220 are slid in a direction opposite to a direction in which the first pipe semi-finished product 410 is formed.

Next, as illustrated in FIG. 6D, when the first upper mold 210 and the first lower mold 220 are separated from the first pipe semi-finished product 410, form removal is performed on the first pipe semi-finished product 410 from the first upper mold 210 and the first lower mold 220 (S140).

The second compression molding machine 300 for molding the second pipe semi-finished product 420 includes a second upper mold 310 and a second lower mold 320.

As illustrated in FIG. 6E, the pipe material 401 made of the PP and the LGF is placed between the second upper mold 310 and the second lower mold 320 of the second compression molding machine 300 (S150).

Next as illustrated in FIG. 6F, the second upper mold 310 and the second lower mold 320 are slid toward the pipe material 401 (S160).

That is, as illustrated in FIG. 6G, the pipe material 401 made of the PP and the LGF is pressed by an upper recessed part 312 of the second upper mold 310 and a lower protrusion 322 of the second lower mold 320 to form a second pipe semi-finished product 420 having a half-pipe shape (S170).

Further, a flange 421 is formed at a position corresponding to the flange 413 of the first pipe semi-finished product 410 on the outer circumferential surface of the second pipe semi-finished product 420 by the upper flange forming part 313 formed in the second upper mold 310.

Further, the second upper mold 310 and the second lower mold 320 are slid in a direction opposite to a direction in which the second pipe semi-finished product 420 is formed.

Next, as illustrated in FIG. 6H, when the second upper mold 310 and the second lower mold 320 are separated from the second pipe semi-finished product 420, form removal is performed on the second pipe semi-finished product 420 from the second upper mold 310 and the second lower mold 320 (S180).

Next, as illustrated in FIG. 6I, the pipe 400 is formed by coupling the first pipe semi-finished product 410 molded using the first compression molding machine 200 and the second pipe semi-finished product 420 molded using the second compression molding machine 300 (S190).

Specifically, in the formation of the pipe 400 by coupling the first pipe semi-finished product 410 and the second pipe semi-finished product 420, the flange 413 of the first pipe semi-finished product 410 and the flange 421 of the second pipe semi-finished product 420 are coupled to each other in a rivet coupling method.

The rivet coupling method may be performed by fastening a rivet bolt and a rivet nut.

Further, in the formation of the pipe 400 by coupling the first pipe semi-finished product 410 and the second pipe semi-finished product 420, the flange 413 of the first pipe semi-finished product 410 and the flange 421 of the second pipe semi-finished product 420 may be coupled to each other in the rivet coupling method. On the other hand, in another example of the formation of the pipe 400 by coupling the first pipe semi-finished product 410 and the second pipe semi-finished product 420, the flange 413 of the first pipe semi-finished product 410 and the flange 421 of the second pipe semi-finished product 420 may be coupled in a welding coupling method.

The welding coupling method may be performed by laser welding or the like.

Further, in the formation of the pipe 400 by coupling the first pipe semi-finished product 410 and the second pipe semi-finished product 420, the flange 413 of the first pipe semi-finished product 410 and the flange 421 of the second pipe semi-finished product 420 may be coupled to each other in the rivet coupling method or the welding coupling method. On the other hand, in still another example of the formation of the pipe 400 by coupling the first pipe semi-finished product 410 and the second pipe semi-finished product 420, the flange 413 of the first pipe semi-finished product 410 and the flange 421 of the second pipe semi-finished product 420 may be coupled to each other by a combination of the rivet coupling method and the welding coupling method.

Therefore, coupling force between the first pipe semi-finished product 410 and the second pipe semi-finished product 420 may be significantly increased.

Accordingly, due to the characteristics of the vehicle, the semi-finished products of the first pipe semi-finished product 410 and the second pipe semi-finished product 420 may be effectively prevented from being separated from each other due to the accumulation of frequent vibrations, such as the shaking of a steering wheel caused by idling and external force, and the like, when the vehicle is stopped or driving.

Further, since a manufacturing process of the pipe 400 for a cowl crossbar includes three processes such as a process of forming the first pipe semi-finished product 410, a process of forming the second pipe semi-finished product 420, and a process of coupling the first pipe semi-finished product 410 and the second pipe semi-finished product 420, a manufacturing cost thereof may be significantly reduced. The number of processes in the manufacturing process of the pipe 400 for a cowl crossbar may be reduced and a manufacturing time of the pipe 400 for a cowl crossbar may be reduced, and thus a time from manufacturing to shipment of a finished vehicle may be effectively reduced.

Meanwhile, the pipe 400 which is fixed to left and right sides of the vehicle body includes a large-diameter part 411 and a small-diameter part 412.

Hereinafter, an apparatus for manufacturing a pipe 400 for a cowl crossbar according to another embodiment of the present invention and a pipe 400 will be described with reference to the accompanying drawings.

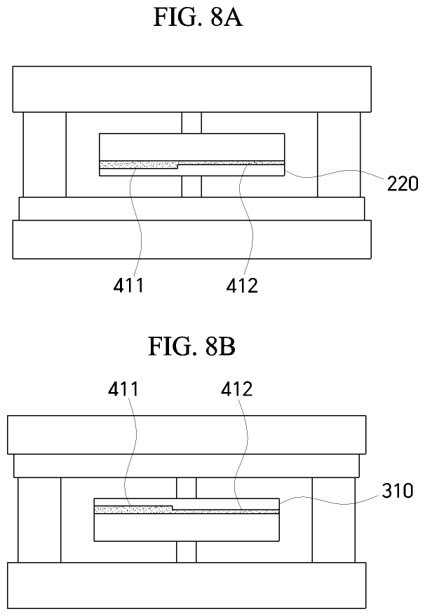

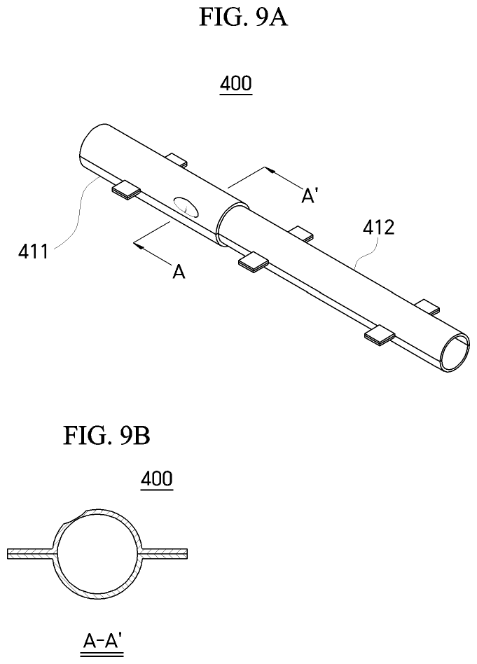

FIGS. 8A and 8B shows views illustrating an apparatus for manufacturing a pipe 400 for a cowl crossbar according to another embodiment of the present invention, and FIGS. 9A and 9B are a perspective view and a cross-sectional view illustrating a pipe 400 manufactured by the apparatus for manufacturing the pipe 400 for a cowl crossbar illustrated in FIGS. 8A and 8B.

A large-diameter part 411 should have rigidity so as to minimize an amount of deformation and a small-diameter part 412 should be able to reduce a total weight of the pipe 400.

Therefore, the rigidity of the large-diameter part 411 and the rigidity of the small-diameter part 412 should be different according to the section.

That is, the large-diameter part 411 is a section that should have rigidity so that the amount of deformation is minimized, and is formed to have a thickness greater than that of the small-diameter part 412, and the small-diameter part 412 is a section in which the total weight of the pipe 400 may be reduced, and is formed to have a thickness smaller than that of the large-diameter part 411.

In other words, an outer diameter of the large-diameter part 411 is greater than an outer diameter of the small-diameter part 412.

To this end, the pipe 400 of the present invention is manufactured by a press method using the first compression molding machine 200 and the second compression molding machine 300 as described above.

Specifically, as illustrated in FIGS. 8A and 8B, the sections of the first lower mold 220 and the second upper mold 310 that form the section of the large-diameter part 411 are formed at a higher position than the sections of the first lower mold 220 and the second upper mold 310 that form the section of the small-diameter part 412.

Therefore, in the pipe 400 of the present invention, when the pipe material 401 is pressed, the first lower mold 220 and the second upper mold 310 that form the section of the large-diameter part 411 the section are brought into contact with the pipe material 401 later than the first lower mold 220 and the second upper mold 310 that form the section of the small-diameter part 412, and thus the large-diameter part 411 and the small-diameter part 412 are formed to have different thicknesses according to shapes of the first lower mold 220 and the second upper mold 310, as illustrated in FIG. 9A.

Accordingly, in the method of manufacturing the pipe 400 of the present invention, the pipe 400 may be manufactured so as to be clearly and easily divided into a section requiring rigidity and a section capable of reducing a weight rather than the rigidity, and in particular, a degree of freedom for manufacturing different thicknesses and shapes of the pipe 400 may be increased.

Further, in the present invention, as illustrated in FIG. 9B, an outer circumferential surface of the pipe 400 may be three-dimensionally formed without a separate foaming process according to the shapes of the first lower mold 220 and the second upper mold 310 to give a foaming effect.

According to the present invention, a pipe can be manufactured in an integrated structure and at the same time, can be manufactured so as to be clearly and easily divided into a section requiring rigidity and a section that can reduce the weight rather than the rigidity according to shapes of an upper mold and a lower mold.

Further, a manufacturing process of a pipe for a cowl crossbar includes three processes, and thus a manufacturing cost thereof can be significantly reduced, and the number of processes in the manufacturing process of the pipe for a cowl crossbar can be reduced and a manufacturing time of the pipe for a cowl crossbar can be reduced, and thus a time from manufacturing to shipment of a finished vehicle can be effectively reduced.

The above-described embodiments should be considered from an exemplary point of view for description rather than a limiting point of view. The scope of the present invention is indicated in the claims rather than the above-described description, and all differences within the scope equivalent thereto should be construed as being included in the present invention.

What is claimed is:

1. An apparatus for manufacturing a pipe for a cowl crossbar, which is disposed inside a vehicle body in a lateral direction, the apparatus comprising:
a first extruder configured to receive a pipe material made of polypropylene (PP) and to extrude the pipe material made of PP;
a second extruder configured to receive the pipe material made of PP extruded from the first extruder and a pipe material made of long glass fiber (LGF), and to extrude a pipe material made of PP and LGF;
a first compression molding machine configured to compress the pipe material made of PP and LGF extruded from the second extruder and to form a first pipe semi-finished product; and
a second compression molding machine configured to compress the pipe material made of PP and LGF extruded from the second extruder and to form a second pipe semi-finished product.

2. The apparatus of claim 1, wherein:
the first compression molding machine comprises a first upper mold configured to press an upper portion of the pipe material extruded from the second extruder and a first lower mold configured to press a lower portion of the pipe material extruded from the second extruder; and
the second compression molding machine includes a second upper mold configured to press the upper portion of the pipe material extruded from the second extruder and a second lower mold configured to press the lower portion of the pipe material extruded from the second extruder.

3. The apparatus of claim 2, wherein:
the first upper mold comprises a first upper body part defining a body and an upper protrusion protruding from the first upper body part; and
the first lower mold comprises a first lower body part defining a body and having an upper surface in contact with a lower surface of the first upper body part, a lower recessed part in which the upper protrusion is inserted, and a lower flange forming disposed on both sides of the lower recessed part in a concave shape.

4. The apparatus of claim 3, wherein the lower flange forming part includes:
a first lower flange forming part disposed at one end of the lower recessed part; and
a second lower flange forming part disposed at another end of the lower recessed part in a direction opposite to the first lower flange forming part,
wherein a central line of the first lower flange forming part and a central line of the second lower flange forming part are different from each other.

5. The apparatus of claim 3, wherein:
the second upper mold comprises a second upper body part defining a body, an upper recessed part recessed from the second upper body part, and an upper flange forming part formed on both sides of the upper recessed part in a concave shape; and
the second lower mold comprises a second lower body part defining a body and having an upper surface in contact with a lower surface of the second upper body part, and a lower protrusion protruding from the second lower body part and configured to be inserted into the upper recessed part.

6. The apparatus of claim 5, wherein the upper flange forming part comprises:
a first upper flange forming part disposed at one end of the upper recessed part; and
a second upper flange forming part disposed at another end of the upper recessed part in a direction opposite to the first upper flange forming part, and
wherein a central line of the first upper flange forming part and a central line of the second upper flange forming part are different from each other.

7. A method of manufacturing a pipe for a cowl crossbar, which is disposed inside a vehicle body in a lateral direction, the method comprising:
placing a pipe material between a first upper mold and a first lower mold;
sliding the first upper mold and the first lower mold in a direction facing each other;
pressing, by the first upper mold and the first lower mold, the pipe material and forming a first pipe semi-finished product;
sliding the first upper mold and the first lower mold in a direction opposite to the direction facing each other and performing form removal on the first pipe semi-finished product from the first upper mold and the first lower mold;
placing the pipe material between a second upper mold and a second lower mold;
sliding the second upper mold and the second lower mold in a direction facing each other;
pressing, by the second upper mold and the second lower mold, the pipe material and forming a second pipe semi-finished product;
sliding the second upper mold and the second lower mold in a direction opposite to the direction facing each other and performing form removal on the second pipe semi-finished product from the second upper mold and the second lower mold; and
forming the pipe by coupling the first pipe semi-finished product and the second pipe semi-finished product.

8. The method of claim 7, wherein the pipe material is a combination of polypropylene (PP) and long glass fiber (LGF).

9. The method of claim 8, wherein a content of the PP is 50%, and a content of the LGF is 50%.

10. The method of claim 8, wherein a content of the PP is 40%, and a content of the LGF is 60%.

11. The method of claim 7, wherein the pipe includes:
a large-diameter part; and
a small-diameter part,
wherein an outer diameter of the large-diameter part is greater than an outer diameter of the small-diameter part.

12. The method of claim 7, wherein, in the forming of the pipe by coupling the first pipe semi-finished product and the second pipe semi-finished product, the first pipe semi-finished product and the second pipe semi-finished product are coupled to each other by rivet coupling.

13. The method of claim 12, wherein the rivet coupling is performed by fastening a rivet bolt and a rivet nut.

14. The method of claim 7, wherein, in the forming of the pipe by coupling the first pipe semi-finished product and the second pipe semi-finished product, the first pipe semi-finished product and the second pipe semi-finished product are coupled to each other by welding coupling.

15. The method of claim 14, wherein the welding coupling includes laser welding.

16. The method of claim 7, wherein, in the forming of the pipe by coupling the first pipe semi-finished product and the second pipe semi-finished product, the first pipe semi-finished product and the second pipe semi-finished product are coupled to each other by a combination of rivet coupling and welding coupling.
